(19) United States
(12) Patent Application Publication
(10) Pub. No.: US 2009/0152430 A1
(43) Pub. Date: Jun. 18, 2009

(54) Brace

(75) Inventors: Fumio Watanabe, Tokyo (JP); Susumu Kono, Kyoto (JP); Eiji Nagai, Osaka (JP); Kyohei Kono, Mie (JP); Takeshi Katayama, Osaka (JP)

Correspondence Address: BUCHANAN, INGERSOLL & ROONEY PC, POST OFFICE BOX 1404, ALEXANDRIA, VA, 22313-1404, US

(73) Assignees: KYOTO UNIVERSITY, Kyoto-shi (JP); Eiji NAGAI, Osaka-shi (JP); DAIWA CORPORATION, Inabe-shi (JP); TAKENAKA CORPORATION, Osaka-shi (JP)

(21) Appl. No.: 11/990,504

(22) PCT Filed: Aug. 2, 2006
(86) PCT No.: PCT/JP2006/315282

§ 371 Date: Nov. 7, 2008

(30) Foreign Application Priority Data
Aug. 17, 2005 (JP) 2005-236452

(51) Int. Cl. F16M 13/00

(52) U.S. Cl. 248/354.1

(57) ABSTRACT

The object is to provide a brace which allows its installment to an object portion and its detachment therefrom to be carried out easily. In a brace including a brace body 3 which is attachable between attaching object portions of a structure, at each one of opposed end portions of the brace body 3, there is provided a contact attaching portion to be attached to the attaching object portion. The brace body 3 includes an expandable urging mechanism S which can be expanded to urgedly extend the brace body 3 along a longitudinal direction thereof, with the two contact attaching portions attached to the attaching object portions and a prestress introducing mechanism P which can be switched over between a state for introducing a compressive prestress to the brace body 3 along the longitudinal direction thereof and a state for releasing the introduced prestress. At least a state switchover control portion 22 of the prestress introducing mechanism is provided to be exposed outside the brace body 3.

### TECHNICAL FIELD

The present invention relates to a brace including a brace body which is attachable between attaching object portions of a structure.

### BACKGROUND ART

With a first conventional example of the brace of this kind, as shown in FIG. 12, a brace body 3 is formed of precast concrete. The brace body 3 includes, at opposed ends thereof, contact attaching portions 4, each of which is to be attached to a corresponding attaching object portion 2 of a structure B by charging filling material 30 between the attaching portion 4 and the object portion 2 (see e.g. Patent Document 1).

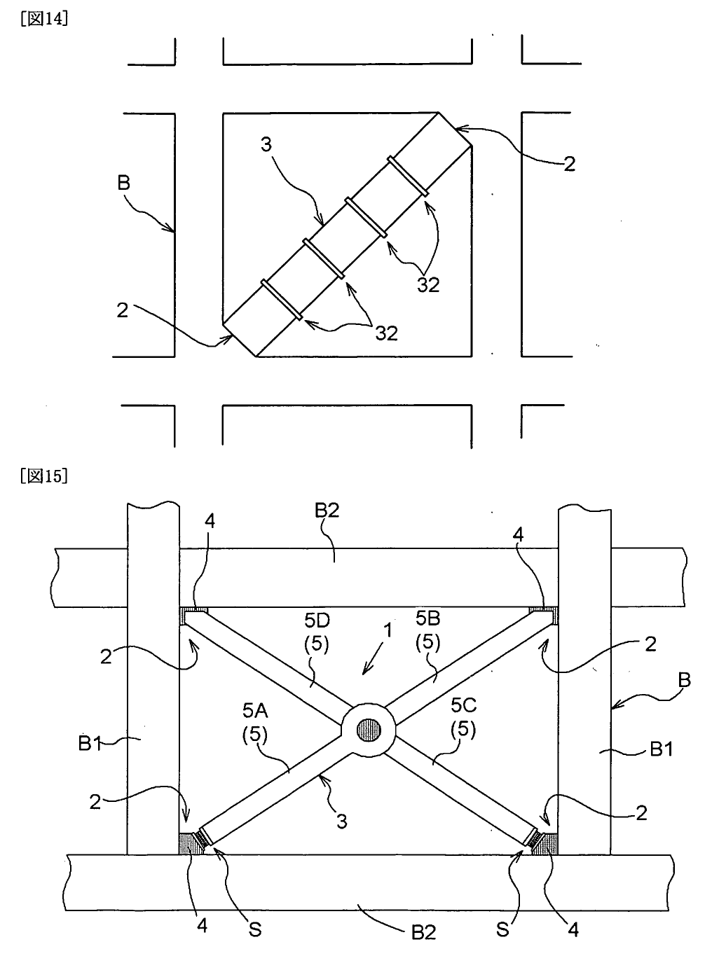

With a second conventional example of the brace, as shown in FIG. 13, through a cross section of a brace body 3 made of precast concrete, a PC steel wire 31 is inserted along the longitudinal direction (see e.g. Patent Document 2).

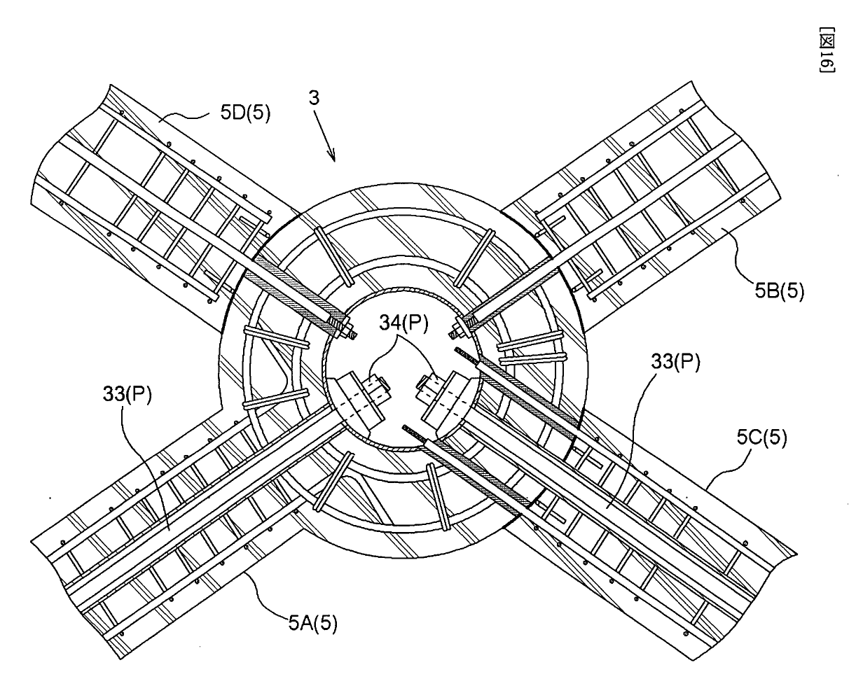

With a third conventional example of the brace, as shown in FIG. 14, a brace body 3 made of concrete is affixed to attaching object portions 2 of a structure B. The brace body 3 includes an unbonded reinforcing steel member. Further, the brace body 3 forms, within the cross section thereof, isolating portions 32 for isolating a tensile force applied along the axial direction of the brace (see e.g. Patent Document 3).

According to the above-described first exemplary brace, during deformation of the structure resulting from e.g. a rocking motion oscillation of an earthquake, the braces arranged along the diagonal lines of the structure experience a compressive force and a tensile force alternately in synchronism with the cycle of the rocking motion. Hence, in order to prevent detachment of the brake body from the structure which may result from application of such compressive and tensile forces thereto, the structure and the brace need to be formed strong, especially at the mutual engaging portions thereof. For instance, it is necessary to increase the mutual bonding force by such method as removing first a portion of mortar of a pillar and/or beam and then embedding a stud therein to be integrated with the brace. Therefore, the installment work efficiency of the brace tends to be poor and there tend to occur such problems as cost increase associated with the poor efficiency, generation of noise during the mortar removing work, etc.

According to the above-described second exemplary brace, a prestress needs to be applied not only to the brace, but to the structure. Therefore, it is necessary to configure the structure too to allow embedding of the PC steel wire therein. Therefore, the construction of the structure tends to be complicated. And, the installment thereof tends to be troublesome. In particular, in case this brace is to be installed as an earthquake resistance enhancement work for an existing building, it is necessary to carry out the installment with change in the construction of the structure. Therefore, the efficiency of the brace installment work tends to be significantly deteriorated and the costs tend to be high due to delay in the work associated therewith. Furthermore, since the insertion holes for inserting PC wires need to be provided also in the structure, there is still another problem of inevitable noise generation.

Further, in order to arrange the brace between the attaching object portions of the structure, very high precision is required in the size of the distance between the attaching object portions as well as in the length of the brace. Therefore, there is a further problem of a great trouble being required in forming the structure and the brace for the improvement in the dimension precisions thereof.

According to the above-described third exemplary brace, within the cross section of the brace body, there are formed isolating portions for isolating a tensile force applied along the axial direction of the brace. Therefore, with these isolating portions, stress concentration due to tensile force can be relieved . However, as described hereinbefore, in association with vibration due to an earthquake or the like, the brace is subjected to a compressive force and a tensile force alternately, so that the brace tends to be detached from the structure. Therefore, like the first example described above, the mutual engaging portions of the structure and the brace need to be formed especially strong. For instance, in case the brace is to be attached to an existing structure, it is necessary to increase the mutual bonding force by such method as first removing a portion of mortar of a pillar or beam and then embedding a stud therein to be integrated with the brace. Therefore, the installment work efficiency of the brace tends to be poor and there tend to occur such problems as cost increase associated with poor efficiency, generation of noise during the mortar removing work, etc.

Then, a fourth exemplary brace as follows can be cited as one designed to overcome the above-described problems and to allow speedy installment as well as attachment of the brace under a stable condition.

With this, as shown in FIGS. 15 through 17, the brace body 3 is divided along its longitudinal direction into two split brace members 5. To one split brace member 5A, there is attached a spring member (corresponding to an “expandable urging mechanism”) S, so as to be expandable and contractible. The two split brace members 5A, 5B will be arranged in series between attaching object portions 2 of the structure, with a prestress in a compressing direction being applied to one split brace member 5A along its entire length. Thereafter, the prestress will be released, thus allowing the brace body 3 attached taut between the attaching object portions 2.

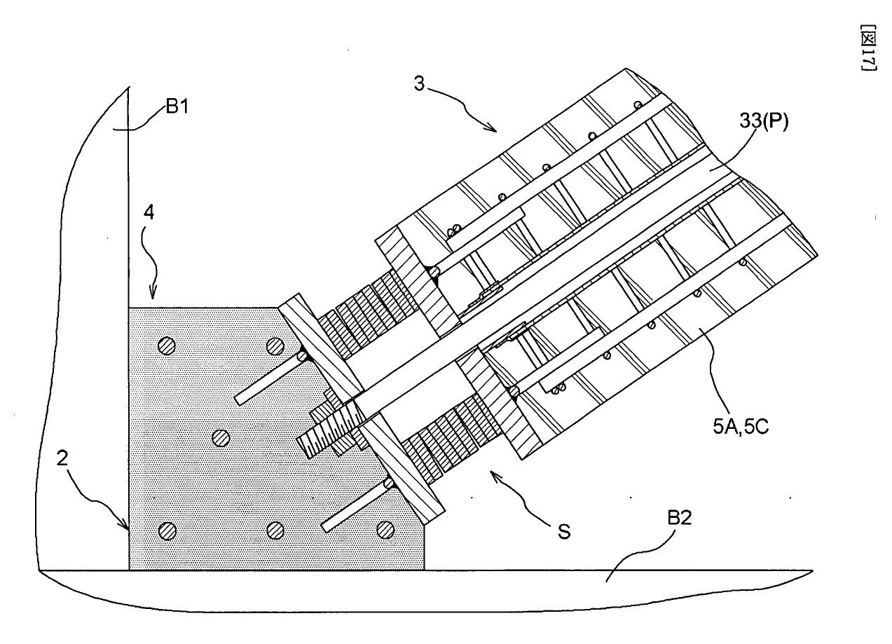

More particularly, as shown in FIG. 16, the one split brace member 5A to which the prestress is to be applied, incorporates therein a prestress introducing mechanism P consisting of a prestress introducing steel bar 33 and a control nut (corresponding to a “state switchover control portion”) 34, the mechanism P being housed within an axial portion of the split brace member 5A, and the one split brace member 5A further incorporates the spring member S which is contracted when the prestress is exerted by the steel bar 33 and is expanded when the prestress is released (see FIG. 17).

And, the control nut 34 for releasing the prestress of the one split brace member 5A is provided at each end of the split brace member 5A, 5C, with the periphery of the nut being covered. After the prestress releasing operation, mortar, concrete or the like will be charged into the covering space so as to reinforce the split brace and also to prevent the control nuts from being exposed to the outside (see Patent Document 4).

Patent Document 1: Japanese Patent Application “Kokai” No. 6-193135

Patent Document 2: Japanese Patent No. 2613552

Patent Document 3: Japanese Patent No. 3111291

Patent Document 4: Japanese Patent No. 3541186

### DISCLOSURE OF THE INVENTION

### Problem to be Solved by Invention

The above-described conventional brace (the fourth example) has the feature of allowing speedy and trouble-less installment work which was not possible with the first through third examples. However, after once installed, if the brace is to be detached, this requires demolition of the brace per se. Hence, the detaching operation was very troublesome.

Regarding the detachment of brace, this is sometimes effected when needed for relocating the brace from its present place to another or effecting a maintenance of the brace.

And, referring to a practical example of brace relocation, this often is effected for a warehouse or a tenant building whose indoor layout is changed with relatively high frequency. So, the relocation of the brace to another place sometimes may become needed with such change of layout.

Regarding this brace relocation, in the case of the conventional braces, the relocation would require both a work for demolishing the old brace and a work for installing a new brace. So, there is another problem of high cost.

Therefore, the object of the present invention is to provide a brace which solves the above-described problems and allows its installment to an object portion and its detachment therefrom to be carried out easily.

### Means to Achieve the Object

According to a first characterizing feature of the present invention, a brace including a brace body which is attachable between attaching object portions of a structure,

wherein at each one of opposed end portions of the brace body, there is provided a contact attaching portion to be attached to the attaching object portion;

the brace body includes an expandable urging mechanism which can be expanded to urgedly extend the brace body along a longitudinal direction thereof, with the two contact attaching portions attached to the attaching object portions and a prestress introducing mechanism which can be switched over between a state for introducing a compressive prestress to the brace body along the longitudinal direction thereof and a state for releasing the introduced prestress; and

at least a state switchover control portion of said prestress introducing mechanism is provided to be exposed outside the brace body.

According to the above-described first characterizing feature of the present invention, the expandable urging mechanism allows the ends of the brace per se to be urgedly attached to the attaching object portions of the structure. And, with the resultant increase in the contact force between the brace and the attaching object portions, these are placed in firm contact with each other, so that the brace can be maintained under a hardly detachable condition.

Even when a compressive force and a tensile force are applied alternately between the contact attaching portions and the attaching object portions of the structure due to a rocking motion of an earthquake as described above, the attachment of the brace can be maintained with little possibility of detachment, thanks to the application of the urging force by the expandable urging mechanism.

As a result, thanks to the expandable urging mechanism, it is possible to maintain strong fixing force at the mutual engaging portions of the structure and the brace. Therefore, unlike the convention, there is no need to employ the troublesome method of first removing a part of mortar of a pillar or beam and then embedding a stud therein to be integrated with the brace. The construction requires only a very simple operation of arranging the brace body between the attaching object portions and attaching it at the contact attaching portions and then allowing the expandable urging mechanism to provide its function. Consequently, the brace can be installed speedily and reliably, thus enabling improvement in the installment work efficiency of the brace. Accordingly, it is possible to achieve cost reduction and to omit the mortar removing operation and reduce noise generation during the brace installment work.

Further, as at least a state switchover control portion of the prestress introducing mechanism is provided to be exposed outside the brace body, it is possible to operate the state switchover control portion from outside the brace body, even with keeping the brace under its installed condition. Hence, the brace installing work as well as the brace removing work can be carried out easily, without demolition of the brace per se.

Therefore, such operations as relocation of the brace, detachment of the brace for its maintenance, etc. can be carried out speedily and economically.

According to a second characterizing feature of the present invention, said prestress introducing mechanism is detachably attached to the brace body.

According to the second characterizing feature of the present invention described above, when a force in the compressing direction is to be applied to the brace body, this operation can be carried out with the prestress introducing mechanism being attached to the brace body. Otherwise, i.e. except when a force in the compressing direction is to be applied to the brace body, it is possible to keep the prestress introducing mechanism detached from the brace body,

Therefore, once the prestress introducing mechanism is attached to the brace body, it is possible to operate the state switchover control portion to allow a compressive prestress to be applied to the brace body. This will be useful when the brace is to be attached between the attaching object portions of the structure or the attached brace is to be detached therefrom. On the other hand, under the installed condition of the brace, it is possible to detach the prestress introducing mechanism from the brace body which is now installed under the stable condition thanks to the expandable urging mechanism. Accordingly, the brace can hardly present an obstacle for other objects. And, it is also possible to prevent deterioration in the aesthetic appearance.

According to a third characterizing feature of the present invention, said prestress introducing mechanism is configured to introduce the prestress along the entire or substantially entire length of the brace body.

According to the third characterizing feature described above, by introducing the prestress along the entire (or substantially entire) length of the brace body, it is possible to allow the brace body as a whole to be contracted by a predetermined amount. Therefore, it becomes possible to apply the prestress while effectively utilizing elastic deformation of the entire brace. Accordingly, the compressing operation of the brace body by the predetermined amount requires a smaller force than a force which would be required for applying the prestress to a limited portion of the brace body. Hence, the prestress introduction operation can be effected with a small and simple device. So that, the device cost reduction is made possible.

According to a fourth characterizing feature of the present invention, said brace body comprises three split brace members split and interconnected along the longitudinal direction.

According to the fourth characterizing feature described above, even when there is a great distance between the attaching object portions, the use of split brace members allows the length of each individual member to be set short. Therefore, the member can be formed compact and can therefore be easily handled, thus enabling improvement in the brace installment work efficiency. And, as the individual member is compact, the brace installment work can be carried out in an efficient manner even at a small space which would not allow installment of the brace therein if the brace were integrated and assembled together from the beginning.

In particular, in the case of e.g. an earthquake resistance enhancement work to be carried out for an existing building, the carry-in of the brace body into the existing building can be carried out smoothly thanks to the compactness of the individual members. Accordingly, the utility of the brace in the installment environment will be improved, and the brace can be handled more easily.

Further, by varying the combination of the split brace members of differing lengths, it is possible to construct braces with various total lengths. Accordingly, a great variety of lengths of the brace can be provided with a small number of members. For instance, if a plurality of types of brace members are prepared with the center one of the three split brace members alone having a different size than the others, it becomes possible to set the total length of the brace greater or smaller as desired, while using the split brace members on the opposed sides of a same size.

Therefore, it becomes possible to construct braces capable of coping with different distances between the attaching object portions, while minimizing the cost of the members.

### BEST MODE OF EMBODYING THE INVENTION

Next, embodiments of the present invention will be described with reference to the accompanying figures. Incidentally, in these figures, components denoted with same reference numerals or marks as those of the conventions are denoted with like reference numerals or marks.

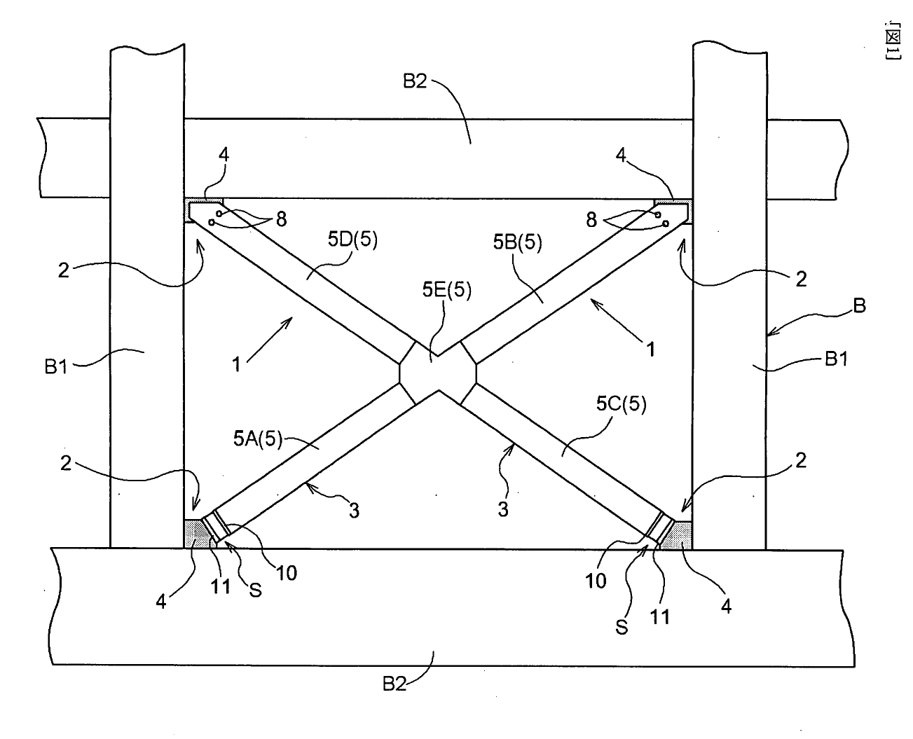

FIG. 1 shows a condition where braces 1 as an embodiment of the inventive brace are attached between attaching object portions 2 of a structure B.

The structure B includes pillars B1 disposed erect with spacing from each other and beams B2 provided integrally between pillars adjacent thereto. Each intersecting portion between the pillar B1 and the beam B2 constitutes the attaching object portion 2.

Each brace 1 is disposed in such a manner as to be located on a diagonal line defined by a rectangular space created within and between the pair of pillars P1 and the pair of beams B2. Accordingly, within the single rectangular space, the two braces 1 are arranged to intersect with each other, with each one of the two braces 1 being attached to the corresponding attaching object portions 2.

Further, each brace 1 includes a brace body 3 formed of a precast member made of ferro-concrete, and contact attaching portions 4 for integrally interconnecting between opposed ends of the brace body 3 and the attaching object portions 2.

The brace body 3 is comprised of three split brace members 5 split and joined to each other along the longitudinal direction.

More particularly, in the front view of FIG. 1, of five split brace members 5 shown, a first split brace member 5A disposed on the left-lower side, a second split brace member 5B disposed on the right-upper side, and an intersection split brace member 5E disposed between the first split brace member 5A and the second split brace member 5B are interconnected and arranged along a common axis, thereby constituting the one brace body 3. Similarly, a third split brace member 5C disposed on the lower-right side, a fourth split brace member 5D disposed on the left-upper side and the intersection split brace member 5E are interconnected and arranged along a common axis, thereby constituting the other brace body 3.

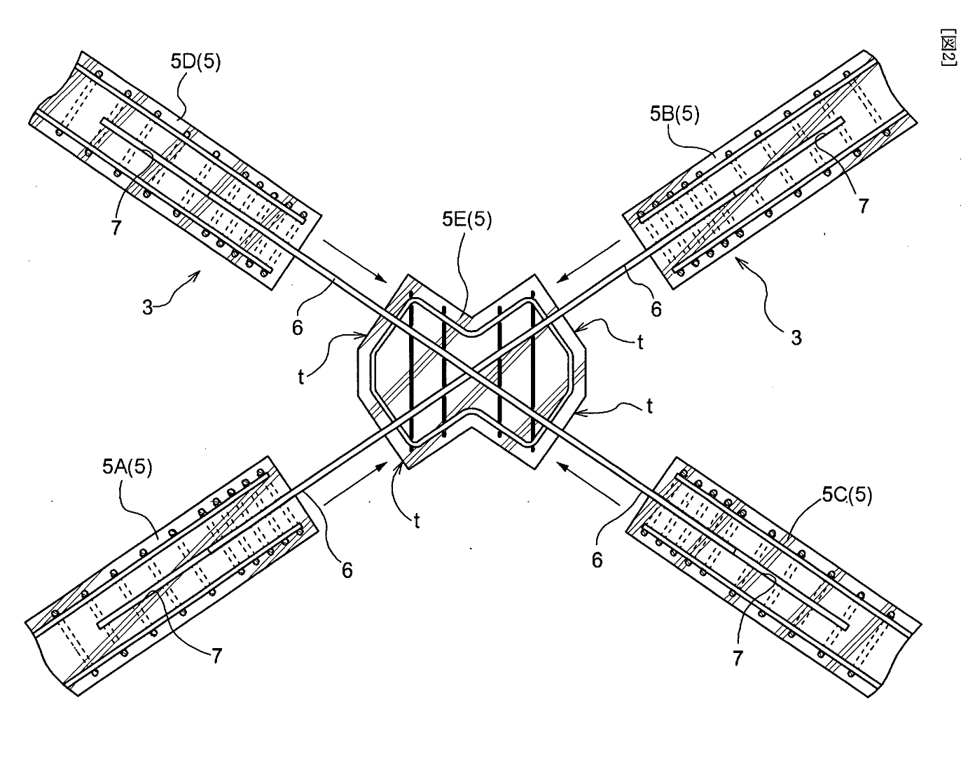

The interconnections between the respective first through fourth spit brace members 5A, 5B, 5C, 5D and the intersection split brace member 5E are comprised of interconnecting reinforcing steels 6 embedded in advance in the intersection split brace member 5E, as shown in FIGS. 2 and 3.

The intersection split brace member 5E includes contact faces (t) which can come into contact respectively with the first through fourth split brace members 5A, 5B, 5C, 5D, and the interconnecting reinforcing steels 6 are embedded so as to project perpendicularly from these contact faces (t) respectively.

On the other hand, at one end portion of each one of the first through fourth split brace members 5A, 5B, 5C, 5D corresponding to the contact face (t), there is embedded a sheath 7 capable of receiving the interconnecting reinforcing steel 6 therein. Then, the respective split brace members 5A, 5B, 5C, 5D are assembled in alignment with each other in such a manner as to engage the interconnecting reinforcing steels 6 within the hollow spaces formed inside the sheathes 7, whereby these components are integrated and connected with each other. Incidentally, the interconnecting strength can be enhanced by effecting the above engagement of the interconnecting reinforcing steel 6 after charging an interconnecting material such as mortar in the hollow inner space of the sheath 7.

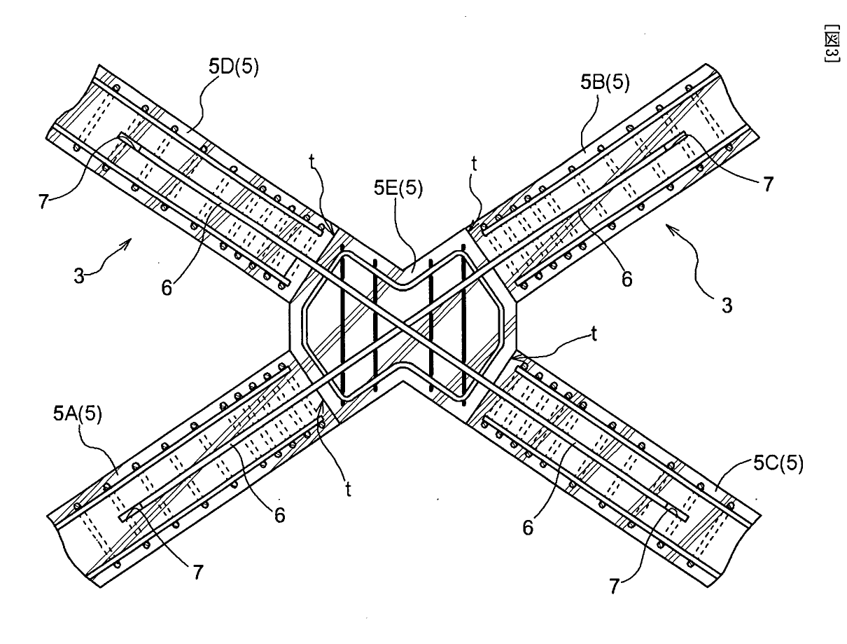

Next, the constructions of and around the other end portions of the first through fourth split brace members 5A, 5B, 5C, 5D (“the other end portions” hereinafter) will be explained (see FIGS. 4-7).

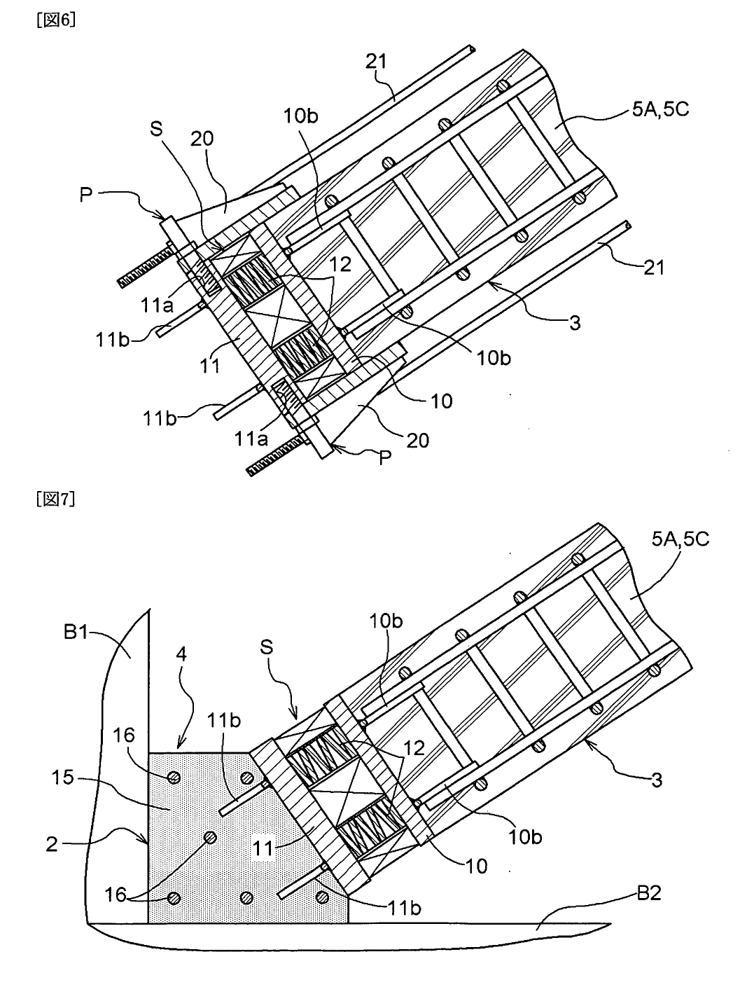

At the other end portion of the first/third split brace member 5A, 5C, as shown in FIG. 6 and FIG. 7, there is provided an expandable urging mechanism S consisting essentially of two metal plates 10, 11 and a plurality of disc spring elements 12 interposed therebetween.

The plurality of disc spring elements 12 allow expansion/contraction, with bearing a compressive force acting along the longitudinal direction of the brace body 3, but not bearing a tensile force acting along the longitudinal direction.

Further, the end side metal plate 11 defines bolt holes 11a to which a prestress introducing mechanism P to be described later can be detachably attached. To these bolt holes 11a, there is bolt-fixed an L-shape flange plate 20 which is one constituting component of the prestress introducing mechanism P. As the L-shape flange plate 20 applies a stress in the direction toward the other end portion of the brace, the disc spring elements 12 are elastically deformed in the compressing direction, whereby a prestress in the compressing direction can be applied to the brace.

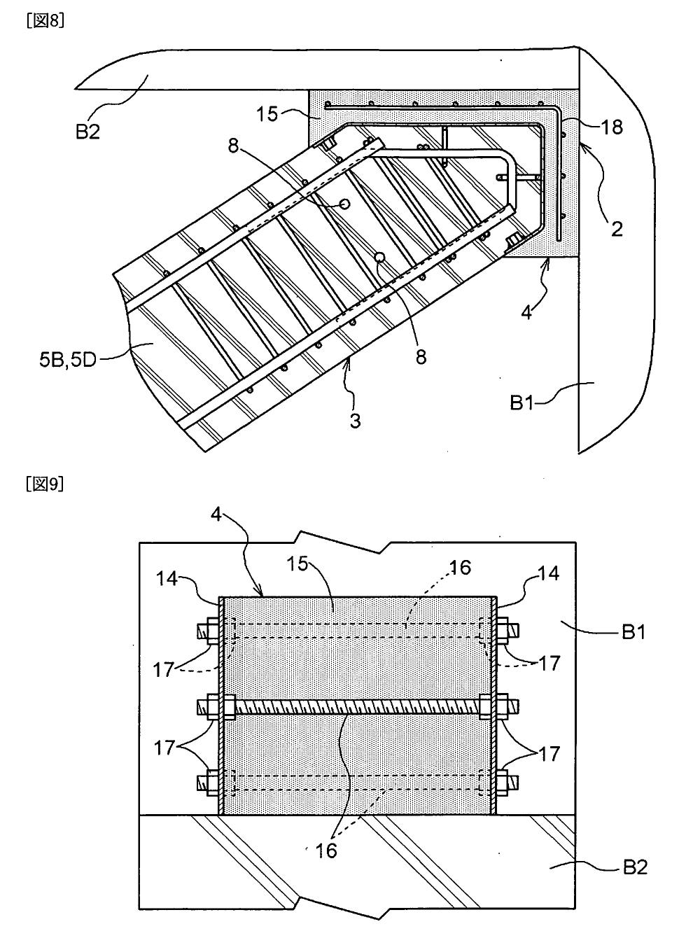

As shown in FIG. 8, the other end portion of the second/fourth split brace member 5B, 5D is formed in a shape of an entry corner portion defined by the pillar B1 and the beam B2, where there is integrally provided a thin metal plate for end protection.

Further, at the other end portion of the second/fourth split brace member 5B, 5D, there is formed a bolt insertion hole 8 extending through the brace along its width direction. And, in this bolt insertion hole 8 also, like the bolt hole 11a described above, a bolt is inserted for detachably fixing the L-shape flange plate 20.

Next, the contact attaching portions 4 formed at the ends of the brace body 3 will be described.

As shown in FIG. 7 and FIG. 9, the contact attaching portion 4 provided between the first/third split brace member 5A, 5C and the attaching object portion 2 is formed by disposing two metal frame members 14 (see FIG. 9) at the entry corner portion with a spacing relative thereto. And, the split brace member 5A, 5C is arranged so as to locate the metal plate 11 at the end of the first/third split brace member 5A, 5C between the two frame members 14, and then high-strength non-compression cement 15 is charged into the gap between the two frame members 14, thereby forming an integral assembly.

Incidentally, to the lower side of the metal plate 11, there is welded an anchor reinforcing steel 11b (see FIG. 7) and as this steel 11b is integrated or solidified with the high strength non-compression concrete 15, there is provided an anchor effect. Further, like the metal plate 11, the metal plate 10 is also integrated or solidified with an anchor reinforcing steel 10b.

Further, as shown in FIG. 9, the two frame members 14 are connected to each other via a plurality of threaded steels 16 extending therethrough and nuts 17 threaded to these threaded steels 16, so that an appropriate spacing may be maintained therebetween.

Like the above-described construction, as shown in FIG. 8, the contact attaching portion 4 provided between the second/fourth split brace member 5B, 5D and the attaching object portion 2 is integrated by charging high strength non-compression cement 15 into the gap therebetween. And, at this charging portion, there is provided a mesh-like reinforcing steel 18 in advance. Then, as this mesh-like reinforcing steel 18 and the high strength non-compression cement 15 are integrated (solidified) with each other, there is realized enhanced strength.

Next, the prestress introducing mechanism P will be described.

The prestress introducing mechanism P includes the above-described L-shape flange plates 20 detachably attached to both side faces of the opposed end portions of the brace body 3, PC steel bars 21 attached to and between the pair of L-shape flange plates 20 opposed to each other along the longitudinal direction of the brace body in such a manner as to pull the plates toward each other, thereby introducing the prestress in the compressing direction to the brace body, and nuts 22 (corresponding to “state switchover operation portions”).

That is, the L-shape flange plates 20 will be bolt-fixed to the brace body 3 with utilizing the bolt insertion holes 8 and the bolt holes 11a. Then, as the PC steel bars 21 inserted to these L-shape flange plates 20 are tensed by means of a jack or the like, a reaction force associated therewith will cause compression of the disc spring elements 12 and at the same time the compressive prestress will be applied to the brace body 3 along its entire length. For maintaining this prestressed condition, this is possible by threading the nuts 22 with the PC steel bars 21.

Further, after the brace body 3 under the above-described prestressed condition is arranged between the structure B and then nuts 22 are loosened, elastic resilience of the brace body 3 including the disc spring elements 12 will become active, so that the brace can be installed under a stretched condition with a predetermined force between the attaching object portions 2.

The brace 1 installed as above can be used as it is. Or, if desired, the prestress introducing mechanism P can be detached therefrom. Further, if there is developed a need to detach the brace 1, it can be easily and speedily detached by attaching the prestress introducing mechanism P again to apply the prestress again thereto. Moreover, with the above construction, as there is no need for demolition of the brace 1, the brace can be installed to its original condition or can be relocated to another place also.

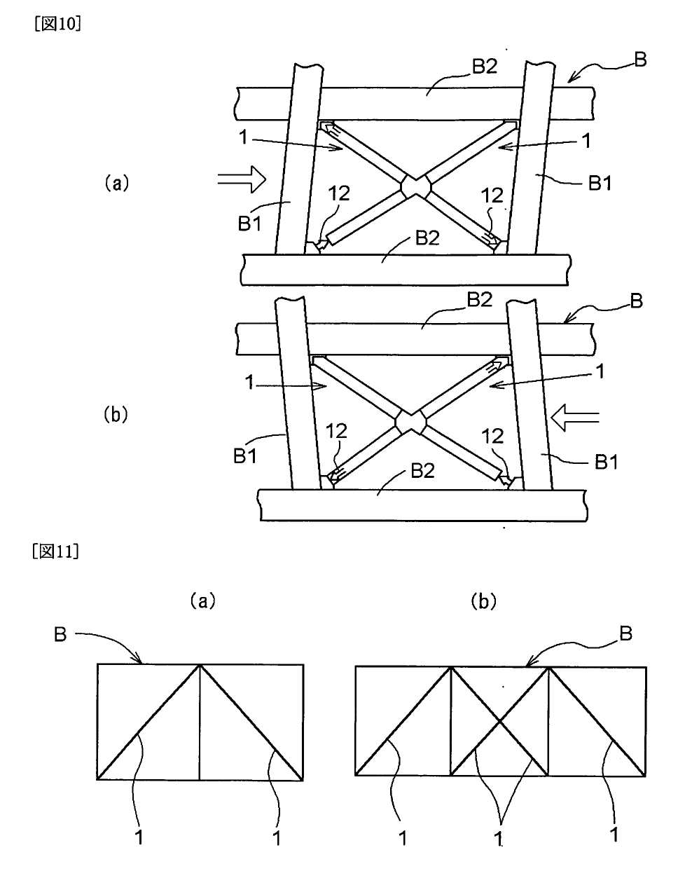

And, as shown in FIG. 10 for instance, in case a rocking vibration due to an earthquake is applied to the structure B, in response to the reciprocation of the rocking motion, the attaching object portions 2 on the diagonal line will move closer to and away from each other alternately in repetition. Then, with the brace 1 according to this embodiment, when the attaching object portions 2 move closer to each other, the compressive force is born by the brace thereby to reduce the rocking motion. On the other hand, when the attaching object portions 2 move away from each other, the disc spring elements 12 which are elastically deformed under the compressed condition will expand in the resilient direction to follow the above movement, so as to prevent tensile force. Therefore, even when concrete material known for its poor tensile strength is used, the brace can provide high compressive strength, thus providing its function fully.

### Other Embodiments

Next, other embodiments will be described.

<1> The brace does not pose any limits in the construction of the structure to which it is attached. For instance, the brace 1 can be used in an RC structure, an S structure, an SRC structure and other various structures.

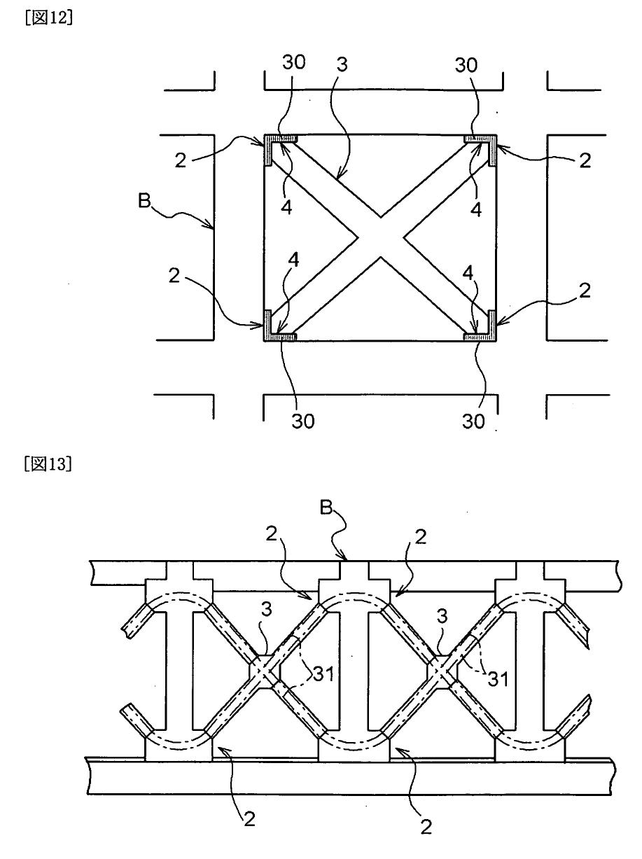

Further, the mode of attachment of the brace 1 to the structure B is not limited to the one described in the foregoing embodiment in which two braces 1 are arranged in an intersecting manner in a rectangular space formed within the structure. For instance, as shown in FIG. 11 (a), a single brace 1 may be installed in each one of a plurality of rectangular spaces formed within the structure B. Or, as shown in FIG. 11 (b), the arrangement of disposing two braces 1 in the intersecting manner and the arrangement of disposing one therein may be used in appropriate combination. In these cases, it is preferred that the arrangements be provided in such advantageous balance as to achieve similar earthquake resistance performance as above against the reciprocation of rocking motion.

<2> The brace body 3 is not limited to the one described in the foregoing embodiment which consists of three split brace members. For instance, the brace body 3 can be a single integral brace body 3. Further, even when the split brace member type construction is employed, this does not need to employ the interconnecting construction described in the foregoing embodiment, but can employ, instead, any other known interconnecting construction.

<3> The expandable urging mechanism S is not limited to the one comprised of the disc spring elements 12 described in the foregoing embodiment. For instance, the expandable urging mechanism S may employ a coil spring instead.

Further, the mechanism can be constituted by utilizing an expandable urging function relying solely on the resilient function inherent in the brace body 3 per se. All of these constructions are generically referred to herein as the “expandable urging mechanism”.

And, the expandable urging mechanism S need not necessarily be provided at one longitudinal end of the brace body 3. Instead, for instance, the expandable urging mechanism S can be provided at a longitudinal intermediate portion of the brace body 3.

<4> The prestress introducing mechanism P is not limited to the one described in the foregoing embodiment comprising the PC steel bars 21 detachably attached to the brace body 3 and the nuts 22. Instead, the prestress introducing mechanism P can be configured to be non-detachable from the brace body 3. And, the tensioning member need not be the PC steel bar 21, but can be a PC steel wire instead. Further, the prestress introducing mechanism P need not be the one which is entirely exposed outside the brace body 3. Rather, what is essential is that at least the state switchover control portion be exposed outside the brace body 3.

Incidentally, in the foregoing description, reference marks are provided in order to facilitate reference to the figures. It is understood; however, that the provision of these marks is not to limit the present invention to the constructions illustrated in the accompanying figures. And, it is needless to say that the present invention can be embodied with various modifications in a range not to deviate from the essential concept of the present invention.

### INDUSTRIAL APPLICABILITY

The present invention is applicable to a variety of braces which include a brace body detachably attached to/between attaching object portions of a structure.

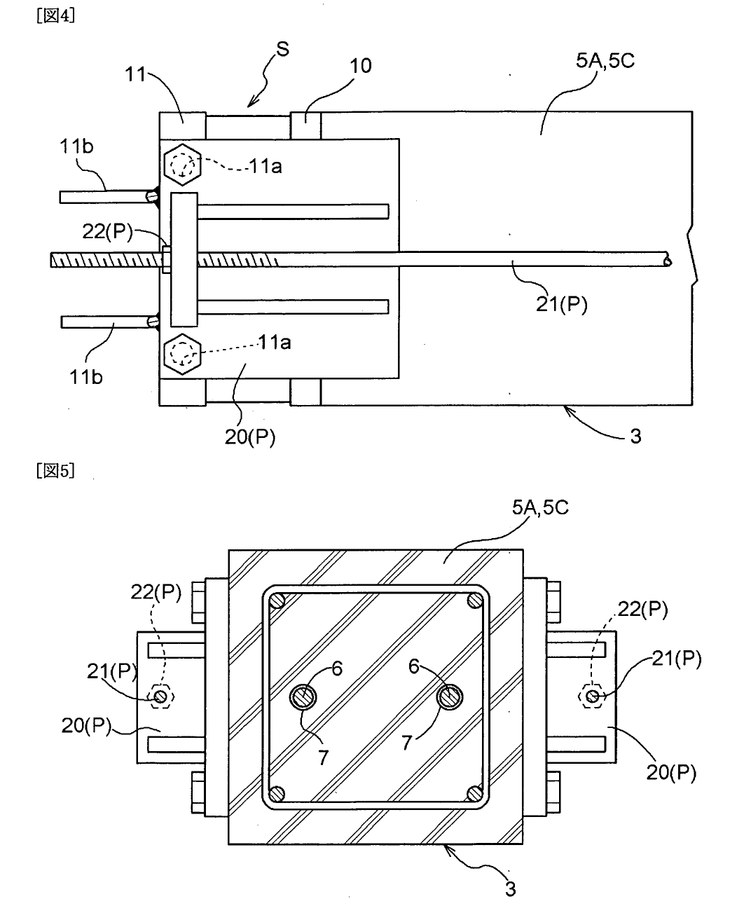

### BRIEF DESCRIPTION OF THE DRAWINGS

[FIG. 1] a front view showing an installment condition of the brace,

[FIG. 2] a front view in cross section showing interconnecting portions of split brace members,

[FIG. 3] a front view in cross section showing interconnected condition of the split brace members,

[FIG. 4] a front view showing an end portion of a first (third) split brace member,

[FIG. 5] a horizontal cross section showing an end portion of the first (third) split brace member,

[FIG. 6] a plan view in cross section showing an end portion of the first (third) split brace member,

[FIG. 7] a front view in cross section showing an end portion of the first (third) split brace member,

[FIG. 8] a front view in cross section showing an end portion of a second (fourth) split brace member,

[FIG. 9] a side view in cross section showing a contact attaching portion of an end portion of the first (third) brace member,

[FIG. 10] conceptual views showing deformed conditions of the brace,

[FIG. 11] a conceptual view showing an installment condition of a brace according to a further embodiment,

[FIG. 12] a front view showing an installment condition of a conventional brace,

[FIG. 13] a front view showing an installment condition of a conventional brace,

[FIG. 14] a front view showing an installment condition of a conventional brace,

[FIG. 15] a front view showing an installment condition of a conventional brace, s

[FIG. 16] a front view in cross section showing a center portion of the conventional brace,

[FIG. 17] a front view in cross section showing an end portion of the conventional brace.

### DESCRIPTION OF REFERENCES MARKS

2 attaching object portion

3 brace body

4 contact attaching portion

5 split brace member

22 nut (corresponding to “state switchover control portion”)

P prestress introducing mechanism

S expandable urging mechanism

1. A brace including a brace body which is attachable between attaching object portions of a structure,
wherein at each one of opposed end portions of the brace body, there is provided a contact attaching portion to be attached to the attaching object portion;
the brace body includes an expandable urging mechanism which can be expanded to urgedly extend the brace body along a longitudinal direction thereof, with the two contact attaching portions attached to the attaching object portions and a prestress introducing mechanism which can be switched over between a state for introducing a compressive prestress to the brace body along the longitudinal direction thereof and a state for releasing the introduced prestress;
said prestress introducing mechanism includes pulling steel bars disposed in symmetry on outer sides across a center axis of the brace body alone the longitudinal direction of the brace body; and
at least a state switchover control portion of said prestress introducing mechanism is provided to be exposed outside the brace body.

2. The brace according to claim 1, wherein said prestress introducing mechanism is detachably attached to the brace body.

3. The brace according to claim 1, wherein said prestress introducing mechanism is configured to introduce the prestress along the entire or substantially entire length of the brace body.

4. The brace according to claim 1, wherein said brace body comprises three split brace members split and interconnected along the longitudinal direction.
